(19) United States
(12) Patent Application Publication
(10) Pub. No.: US 2004/0242697 A1
(43) Pub. Date: Dec. 2, 2004

(54) Methods of reducing pests by use of iodoacetic acid, bromoacetic acid, 2-iodoacetamide, or 2-bromoacetamide

(76) Inventors: Erin N. Rosskopf, Fort Pierce, FL (US); Leonard L. Therrien, Sebastian, FL (US); William H. Basinger, Hiram, GA (US)

Correspondence Address: USDA, ARS, OTT, 5601 SUNNYSIDE AVE, RM 4-1159, BELTSVILLE, MD, 20705-5131, US

(21) Appl. No.: 10/828,802

(22) Filed: Apr. 20, 2004

Related U.S. Application Data
(60) Provisional application No. 60/464,575, filed on Apr. 22, 2003.

(51) Int. Cl. A01N 37/10; A01N 37/18

(52) U.S. Cl. 514/617; 504/321

(57) ABSTRACT

A method for reducing pests in an object or area by applying to the object or area a pest reducing effective amount of iodoacetic acid, bromoacetic acid, 2-iodoacetamide, 2-bromoacetamide, or mixtures thereof. The pests may be, for example, fungi, insects, nematodes, bacteria, weeds, or mixtures thereof. The object or area may be, for example, soil, structures, agricultural commodities, plants, or mixtures thereof.

### REFERENCE TO RELATED APPLICATION

This application claims the benefit of U.S. Provisional Application No. 60/464,575, filed 22 Apr. 2003, which is incorporated herein by reference in its entirety.

### BACKGROUND OF THE INVENTION

The present invention relates to a method for reducing pests in an object or area by applying to the object or area a pest reducing effective amount of iodoacetic acid, bromoacetic acid, 2-iodoacetamide, 2-bromoacetamide, or mixtures thereof. The pests may be, for example, fungi, insects, nematodes, bacteria, weeds, or mixtures thereof. The object or area may be, for example, soil, structures, agricultural commodities, plants, or mixtures thereof.

Methyl bromide is the chemical fumigant currently utilized to control fungi, nematodes, weeds, and insects in soil. It is used for the production of high value agricultural crops such as strawberries, tomatoes, and peppers. In 1992, methyl bromide was implicated as an ozone-depleting compound and subsequently the production levels of methyl bromide were frozen. Methyl bromide is targeted for a 5-year phase-out beginning in the year 2000 and may be completely phased out by the year 2005. The agricultural producing states most affected by this phase-out are Florida and California, which produce the majority of the tomatoes, peppers, and strawberries grown in the United States. The aforementioned crops are the largest consumers of methyl bromide for soil fumigation purposes. As methyl bromide is phased out, current crop yields are expected to reduce by as much as forty percent due to increased pest pressure in non-fumigated soil. Vegetable growers are currently dependent on use of this soil fumigant with the greatest impact of its phase-out projected to be on U.S. fresh market and a total economic loss for vegetable production estimated to exceed $479 million. Weed control in the absence of methyl bromide is considered to be the area of greatest concern to growers. There currently exist a limited number of chemicals that are frequently studied as methyl bromide alternatives: 1,3-dichloropropene, chloropicrin, metham sodium, dazomet, methyl iodide, propargyl bromide, sodium azide, furfural, and Enzone (EPA, Methyl Bromide Web Page). None of these are considered to be drop-in replacements for methyl bromide based on performance, toxicity, or economics (drop-in replacement means that methodology, equipment, production system, etc. do not have to be changed significantly and that a comparable amount of material can be used for the same targets; i.e., the material is applied at nearly the same rate and with the same equipment as methyl bromide). None of the acceptable alternatives provide adequate weed control, particularly of nutsedge and grass weeds. Nutsedge is considered to be the world's worst weed due to its status as a competitor with more crops in more countries than any other weed. Purple nutsedge grows well in almost any soil type and over a wide range of soil pH, moisture, and elevation. This weed is a significant problem in field crops, horticultural crops, and turf. Yields of some crops can be reduced by as much as 90% as a result of competition with this weed. Plant pathogenic fungi and nematodes, particularly root-knot nematode (Meloidogyne spp.) are also targets of any alternative fumigant.

### SUMMARY OF THE INVENTION

The present invention relates to a method for reducing pests in an object or area by applying to the object or area a pest reducing effective amount of iodoacetic acid, bromoacetic acid, 2-iodoacetamide, 2-bromoacetamide, or mixtures thereof. The pests may be, for example, fungi, insects, nematodes, bacteria, weeds, or mixtures thereof. The object or area may be, for example, soil, structures, agricultural commodities, plants, or mixtures thereof.

### BRIEF DESCRIPTION OF THE DRAWINGS

FIG. 1 shows results of testing 2-bromoacetamide in a Fusarium plate assay;

FIG. 2 shows results of testing 2-iodoacetamide in a Fusarium plate assay;

FIG. 3 shows results of testing bromoacetic acid in a Fusarium plate assay;

FIG. 4 shows results of testing iodoacetic acid in a Fusarium plate assay;

FIG. 5 shows results of testing Benlate® control in a Fusarium plate assay;

FIG. 6 shows results of testing 2-bromoacetamide in a Fusarium tetrazolium assay;

FIG. 7 shows results of testing 2-iodoacetamide in a Fusarium tetrazolium assay;

FIG. 8 shows results of testing bromoacetic acid in a Fusarium tetrazolium assay;

FIG. 9 shows results of testing iodoacetic acid in a Fusarium tetrazolium assay;

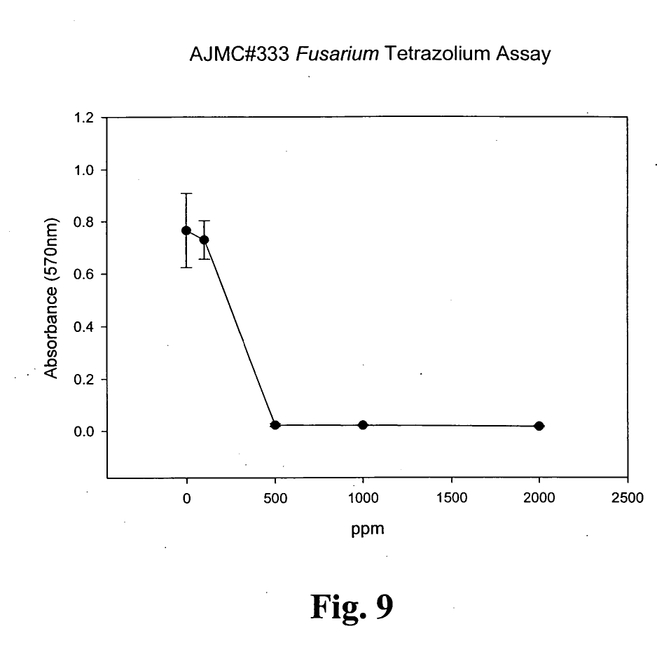

FIG. 10 shows results of testing Benlate® control in a Fusarium tetrazolium assay;

FIG. 11 shows results of testing 2-bromoacetamide in a barnyard grass assay;

FIG. 12 shows results of testing 2-bromoacetamide in a pigweed assay;

FIG. 13 shows results of testing 2-iodoacetamide in a barnyard grass assay;

FIG. 14 shows results of testing 2-iodoacetamide in a pigweed assay;

FIG. 15 shows results of testing bromoacetic acid in a barnyard grass assay;

FIG. 16 shows results of testing bromoacetic acid in a pigweed assay;

FIG. 17 shows results of testing iodoacetic acid in a barnyard grass assay;

FIG. 18 shows results of testing iodoacetic acid in a pigweed assay;

FIG. 19 shows results of testing 2-bromoacetamide in a nutsedge greenhouse assay;

FIG. 20 shows results of testing 2-iodoacetamide in a nutsedge greenhouse assay;

FIG. 21 shows results of testing bromoacetic acid in a nutsedge greenhouse assay;

FIG. 22 shows results of testing iodoacetic acid in a nutsedge greenhouse assay;

FIG. 23 shows results of testing 2-bromoacetamide in a nutsedge greenhouse assay;

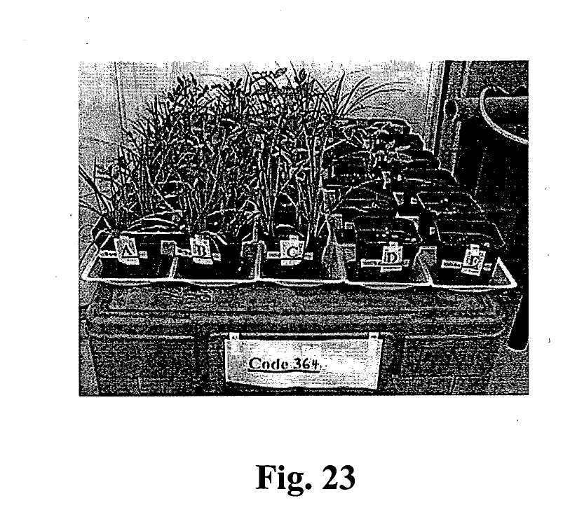

FIG. 24 shows results of testing 2-iodoacetamide in a nutsedge greenhouse assay; and

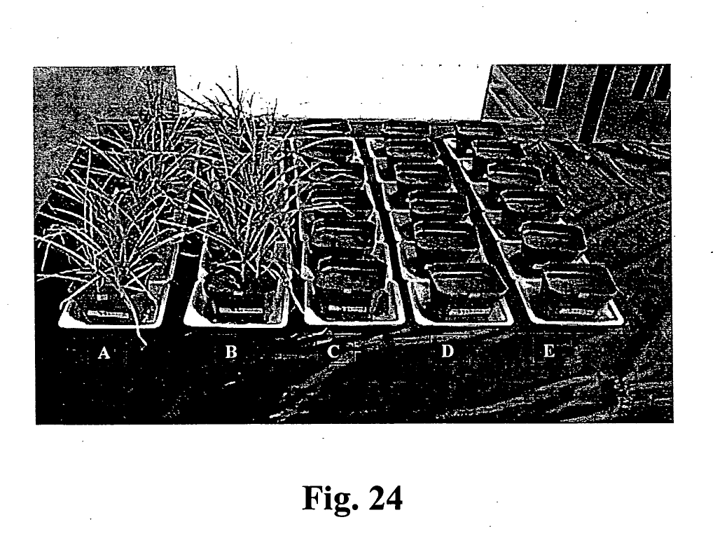

FIG. 25 shows results of testing iodoacetic acid in a nutsedge greenhouse assay.

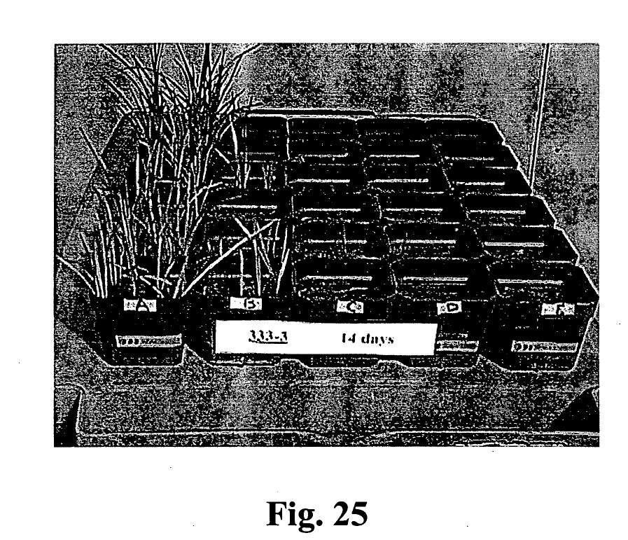

### DETAILED DESCRIPTION OF THE INVENTION

It has been discovered that iodoacetic acid, bromoacetic acid, 2-iodoacetamide, 2-bromoacetamide, or mixtures thereof may be utilized in controlling pests such as fungi, insects, nematodes, bacteria, and weeds, for example by fumigation of soil, structures, agricultural commodities (e.g., wood, grain), and plants. The compounds described herein may be employed in substantially the same manner as is customary for use of methyl bromide, chloropicrin or Telone® C-17 (DowElanco product containing 77.9 percent 1,3-dichloropropene (1,3-D) and 16.5 percent chloropicrin), Telone® C-35, Telone® II, Inline, Metam Sodium, Nemacur®, Vydate®, and other chemical fumigants, nematicides, fungicides, herbicides, or insecticides. The compounds described herein may be used with known agronomically acceptable carrier(s) or carrier component(s).

The mixtures may contain any two or any three or all four of the following: iodoacetic acid, bromoacetic acid, 2-iodoacetamide, 2-bromoacetamide.

Application of iodoacetic acid, bromoacetic acid, 2-iodoacetamide, 2-bromoacetamide, or mixtures thereof in accordance with the present invention may be effected by a number of different procedures as are currently routinely employed for soil and structural treatments with, for example, methyl bromide. Thus, for example, the compounds may be applied to the soil by tractor mounted injectors on tynes, manually in canisters and via an existing irrigation system or as a gas through lay flat tubing; furthermore, for example, the compounds may be applied by drip irrigation, shanking in, spray/rototill, or overhead sprinklers. The compounds may be dissolved in suitable solvents (e.g., water, alcohols, ethers, petroleum based solvents) and/or emulsified to assist in dispersion of the material during the treatment of, for example, soil and agricultural substances. The compounds may be heated to form a gas. Further, it is contemplated as within the scope of the invention to apply mixtures of the compounds with other fumigants, nematicides, herbicides or other agricultural chemicals, for example methyl bromide, chloropicrin, Inline® or Telone® C-17.

A wide range of application rates of the compounds may be suitable in accordance with the present invention. Those working in this field would of course be readily able to determine in an empirical manner the optimum rates of application for any given combination of plants (e.g., crops), soils, structures, and the target organisms to be killed or eliminated. The amount of compound used will be at least an effective amount to reduce pests. The term “pest reducing effective amount,” as used herein, means the minimum amount of iodoacetic acid, bromoacetic acid, 2-iodoacetamide, 2-bromoacetamide, or mixtures thereof needed to reduce the number of pests (e.g., fungi, insects, nematodes, bacteria, or weeds) in an object or area (e.g., soil, structures, plants, or agricultural commodities such as grain or wood). As would be readily appreciated by a person skilled in the art, the delivery of the compounds can be calculated in terms of the active ingredient applied per unit area. For example, the compounds may be applied at the rate of 10-1200 pounds/acre, preferably 100-400 pounds/acre; applications of the compounds at rates substantially in excess of 1200 pounds/acre would not be expected to provide any significant advantage over applications within the ranges specified herein, but are nonetheless regarded as well within the scope of the present invention. Of course, the precise amount of the compounds needed will vary in accordance with the particular composition used; the type of area or object to be treated; the number of days of effectiveness needed; and the environment in which the area or object is located. The precise amount of the compounds can easily be determined by one skilled in the art given the teaching of this application. Other compounds may be added to the iodoacetic acid, bromoacetic acid, 2-iodoacetamide, 2-bromoacetamide, or mixtures thereof provided they do not substantially interfere with the intended activity of the iodoacetic acid, bromoacetic acid, 2-iodoacetamide, 2-bromoacetamide, or mixtures thereof; whether or not a compound interferes with activity can be determined, for example, by the procedures described below. Such other compounds include, for example, pesticides or chemicals such as chloropicrin, metam sodium, 1,3-dichloropropene(s), Plant Pro®, propylene oxide, basamid, alkyl iodides), generally in ratios in the range of 1:10 to 10:1, in order to enhance efficacy or improve use economics.

A wide range of timing of application of the compounds may be suitable in accordance with the present invention. Those working in this field would of course be readily able to determine in an empirical manner the optimum timing of application for any given combination of crops, soils, structures, and the target organisms to be killed or eliminated. For example, the timing of application may be pre- or post-bedding, pre-transplant, pre-seed, or pre-plant. The compounds may be applied to the soil during the post-planting and/or post-emergence cropping period in levels sufficient to control a target pest or pathogen without hurting the crop (e.g., grapes, peaches, bananas, ornamentals, coffee, etc.). The compounds may also be used on corms, bulbs, or tubers prior to planting and after planting. Furthermore, the compounds may be used as pre- or post-emergent herbicides during or before the cropping season.

Those working in this field would of course be readily able to determine in an empirical manner which organisms may be killed or eliminated by the compounds. Plant pathogenic organisms successfully controlled or eliminated by treatments in accordance with the present invention include, but are not limited to, nematodes, fungi, weeds, bacteria, and insects; for example, nematodes (e.g. Meloidogyne spp. (Root Knot ), Xiphinema spp. (Dagger), Pratylenchus (Lesion), Longidorus spp. (Needle), Paratylenchus spp. (Pin), Rotylenchulus spp. (Reniform), Helicotylenchus spp. (Spiral), Hoplolaimus spp. (Lance), Paratrichodorus spp. (Stubby Root), Tylenchorhynchus spp. (Stunt), Radopholus spp. (Burrowing), Anguina spp. (Seed Gall), Aphelenchoides spp. (Folair), Bursaphelenchus spp. (pinewood), Ditylenchus spp. (Stem, Bulb, and Potato Rot), Trichchodorus spp., Globodera spp. (Potato Cyst), Hemicycliophora spp. (Sheath), Heterodera spp. (Cyst), Dolichodorus spp. (Awl), Criconemoides spp. (ring), Belonolaimus spp. (Sting), Tylenchulus semipenetrans (Citrus)), plant pathogenic fungi (e.g., Cylindrocarpon spp., Fusarium spp., Phoma spp., Phytophthora spp., Pythium spp., Rhizoctonia spp., Sclerotinia spp., Verticillium spp.), plant pathogenic bacteria (e.g., Pseudomonas spp.), and insects (e.g. wireworms, thrips, beetle larva, grubs). Particular plant pathogens and nematodes controlled or eliminated by application of the compounds include, but are not limited to, the following: root rot pathogens (e.g., Phytophthora spp., Pythium spp., Rhizoctonia spp., Fusarium spp.); vascular wilt pathogens (e.g., Verticillium spp., Fusarium spp.); root knot and extoparasitic nematodes (e.g., Meloidogyne spp., Pratylenchus spp., Rotylenchus spp., Tylenchorrhynchus spp., Xiphinema spp.); root lesion nematodes (e.g., Pratylenchus vulnus); ring nematodes (e.g., Circonemella xenoplax); stubby root nematodes (e.g., Paratiichodorus spp.); stem and bulb nematodes (e.g., Ditylenchus dipsaci); cyst nematodes (e.g., Heterodera schachtii); citrus nematodes (e.g., Tylenchulus semipenetrans); and burrowing nematodes (e.g., Radopholus similus). Among the types of weeds controlled or eliminated by application of the compounds include, but are not limited to, the following: purple nutsedge (Cyperus rotundus); smooth pigweed (Amaranthus hybridus); barnyard grass (Echinocola crus-galli); cheeseweed (Malva spp.); field bindweed (Convolvulus arvensis); annual bluegrass (Poa annua); bermuda grass; crab grass; foxtail; purs lane; and witchweed. Particular insects controlled or eliminated by application of the compounds include, but are not limited to, the following: fungal gnat larvae, soil mealy bugs, phylloxera, ants, termites, and animal parasites.

The compounds may be applied to a wide variety of agricultural plants, for example, tomatoes, peppers, carrots, potatoes, strawberries, melons, pineapples, tobacco, bananas, ornamentals, cut flowers, turf/sod, tobacco, trees/seedlings, coffee, orchard crops (e.g., peaches, citrus), and vine crops (e.g., grapes).

The following examples are intended only to further illustrate the invention and are not intended to limit the scope of the invention as defined by the claims.

### EXAMPLES

Materials and Methods

Fusarium Tetrazolium and Petri Plate Assays: The evaluation of fungicidal activity was performed using a modified colorimetric assay ((Mace, M. E., et al., Pesticide Biochemistry and Physiology, 38: 57-59 (1990) as well as a potato dextrose agar-based petri plate assay. For the tetrazolium-based assay, each candidate compound was tested using a suspension of Fusarium oxysporum f. sp. lycopersici (isolate FP-7) spores harvested from 10-day old petri plates using a 0.05% stock solution of Triton X-100 (referred to as FT stock). Harvested spores were suspended in Czapek-Dox Broth (CDB), prepared according to label instructions, at ratio of 1:5 CDB:FT. The suspension was then standardized using a Beckman spectrophotometer (430 nm), which has been calibrated using a CDB blank. Compounds were then added to aliquots of the suspension to achieve active ingredient concentrations ranging from 0 ppm (untreated control) to 2000 ppm. Suspensions were incubated for 24 hr at 28° C. A 10% stock solution of MTT was then added to each aliquot. The suspensions were allowed to incubate for 4 hr, then pelleted, drained, rinsed, and treated with 95% ethanol. The color change, which correlates with spore viability, was assessed using the Beckman spectrophotometer (570 nm), calibrated with 95% ethanol. Benlate (benomyl) was used as an industry standard control. Each treatment was replicated six times and the assay for each compound was repeated. The petri plate-based assay consisted of incorporation of the test material active ingredient in potato dextrose agar to achieve concentrations ranging from 0 ppm (untreated control) to 2000 ppm. A mycelial plug of (cork bore size #3) Fusarium oxysporum f. sp. lycopersici (isolate FP-7) from a 7-day old culture was placed at the center of the plate and the radial growth of the fungus was measured for 7-10 days. Each treatment was replicated six times and the assay for each compound was repeated. Regression analysis was performed using Sigma Plot 2000.

Herbicide Screen: Each candidate compound was tested on seeds of smooth pigweed (Amaranthus hybridus) and barnyard grass (Echinocloa crus-galli), and on tubers of purple nutsedge (Cyperus rotundus) by exposing seeds or tubers to a specific concentration of the test compound. Seeds were surface sterilized and 20 seeds placed on sterile filter paper (Whatman #5) in a 10-cm petri plate for each of six replicates for each weed species tested. Twenty ml of compound of concentrations ranging from 0 ppm (sterile water control) to 2000 ppm was added to the petri dishes. Plates were stored at 30° C. in an dark incubator. Seed germination was monitored at 24 hr intervals for 30 days. Petri plate bioassays were repeated twice for each compound. Field collected purple nutsedge tubers were placed in 500 g of field soil with soil moisture adjusted to 5%. Five nutsedge tubers were planted in each 10-cm pot at a depth of 2.5 cm. Six replicate pots of each concentration, ranging from 0 ppm (water control) to 2000 ppm, will be treated using 100 ml as a soil drench. Pots were tarped with co-extruded black-on-white polyethylene mulch for 7 days. After tarps were removed, the number of emerged nutsedge shoots was recorded on a weekly basis for 60 days.

Nematicide Screen: It is expected that the compounds will be effective against nematodes. Efficacy as a nematicide is evaluated by infesting field soil with a standardized quantity of root-knot nematode eggs. Soil is partitioned into 10-cm pots containing 500 g of soil each with soil moisture adjusted to 5%. Pots are treated with compounds ranging from 0 ppm to 2000 ppm of active ingredient in a 100-ml soil drench. Six replicate pots of each concentration are treated and tarped with co-extruded black-on-white polyethylene mulch for 14 days. After tarps are removed, a single tomato seedling is transplanted into each pot. Seedlings are removed 30 days later and assessed for root galling, root fresh weight, root dry weight, and number of eggs produced per gram of root tissue.

Results and Discussion:

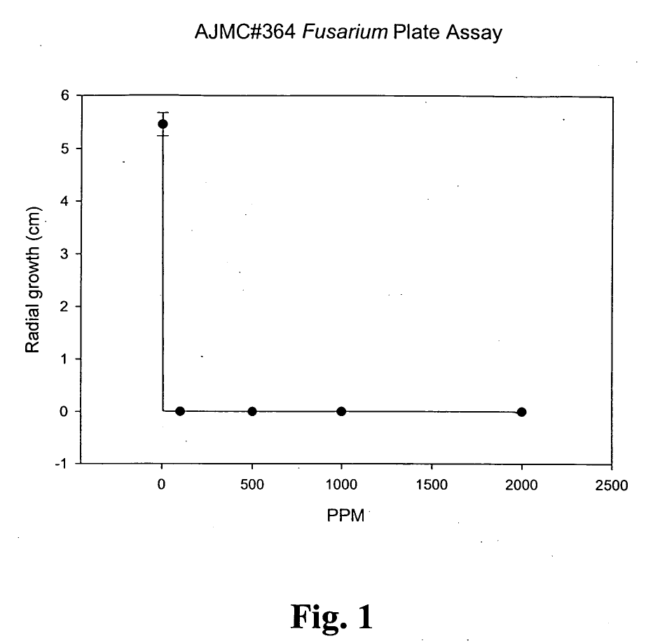

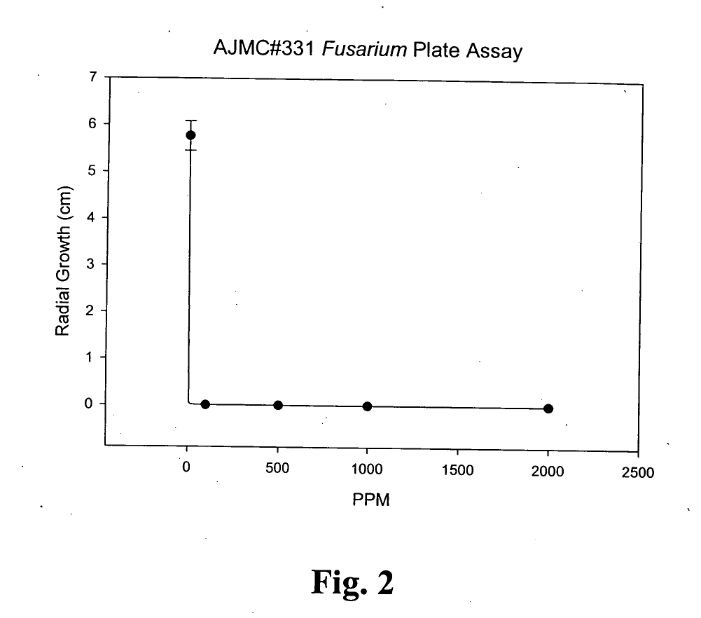

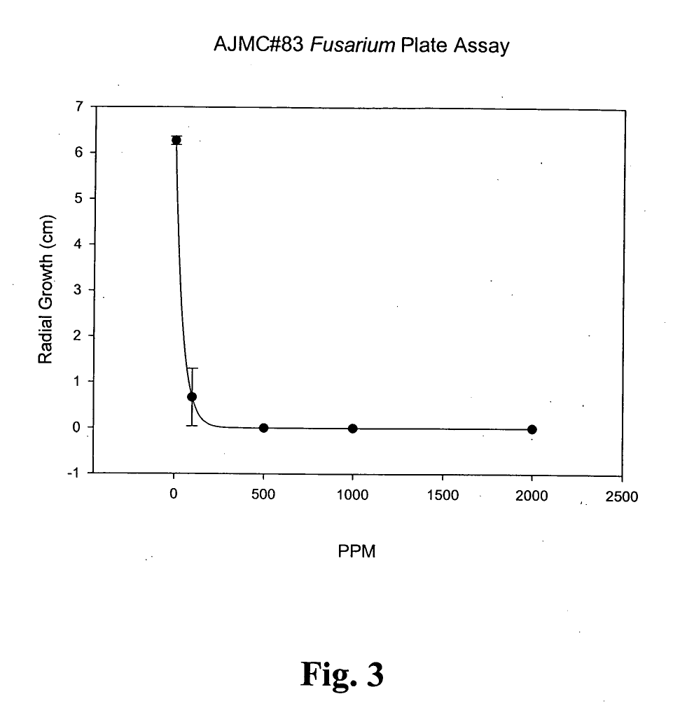

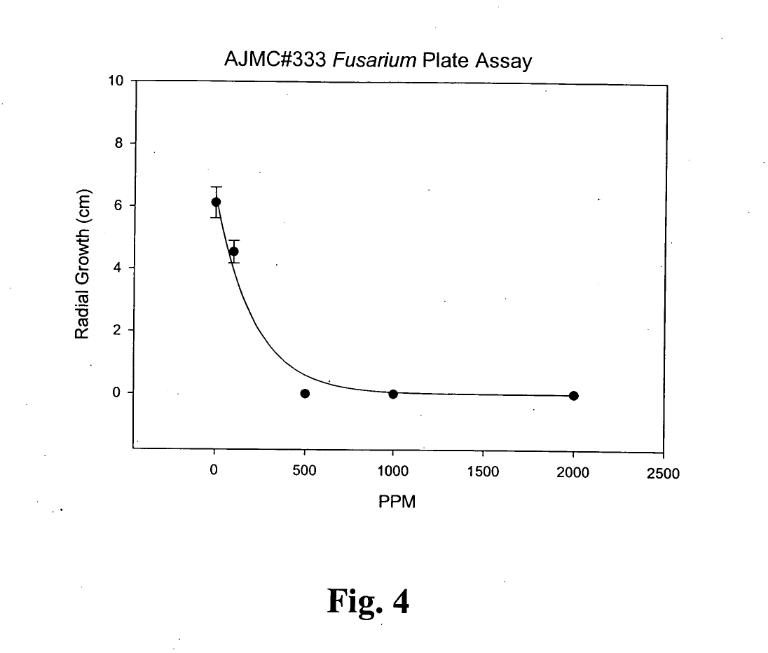

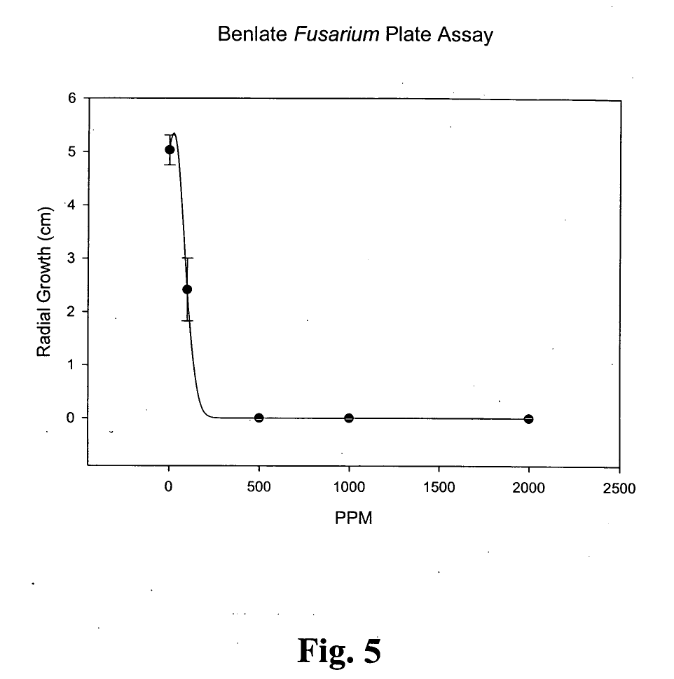

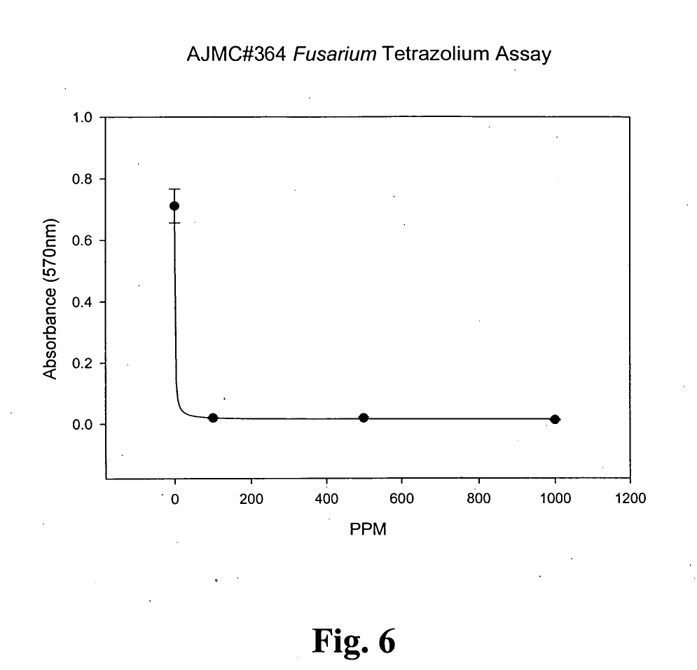

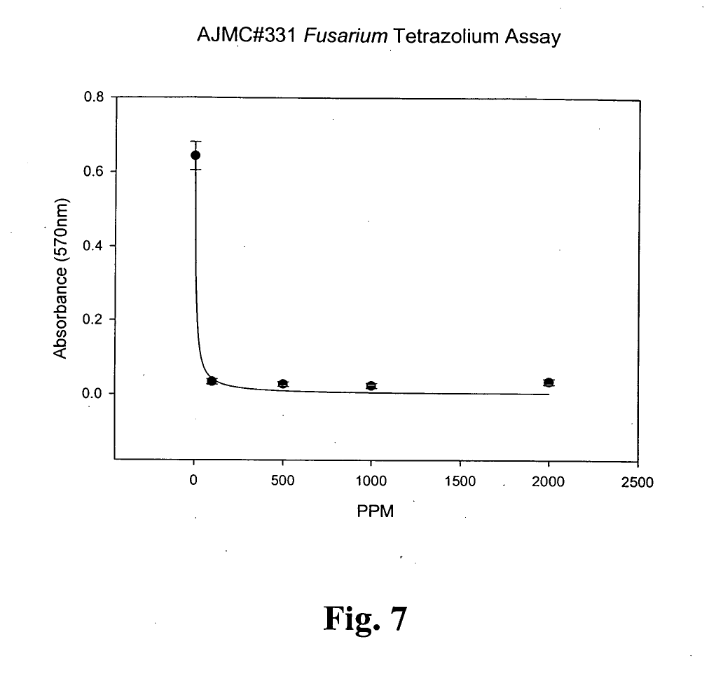

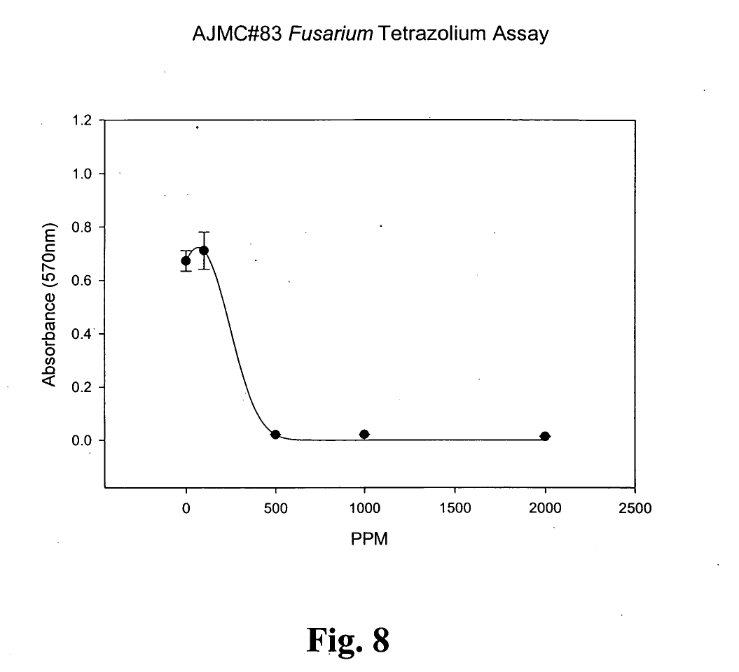

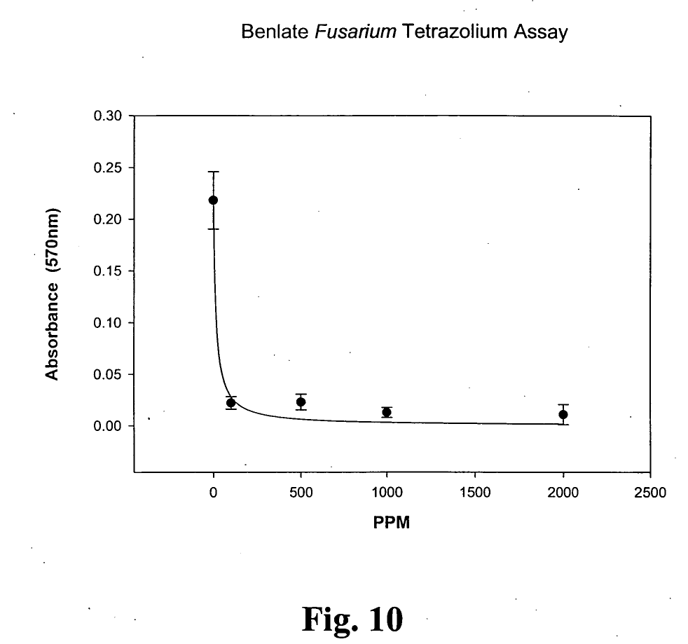

Fusarium Tetrazolium and Petri Plate Assays: Results from these assays appear in FIGS. 1-8 wherein the graphs are plots of the ppm versus resulting absorbance at 570 nm after 24 hours of exposure to the compound in the case of the tetrazolium assay and ppm versus radial growth in centimeters in the case of the PDA assay. The tetrazolium assay is based on a color change produced with a vital stain on living tissue, i.e. the lower the absorbance, the fewer viable cells. In the PDA-based assay, fungal growth was eliminated by bromoacetamide, iodoacetamide, and bromoacetic acid at or slightly above the 100 ppm concentration (FIGS. 1-3), which was significantly better than the Benlate control (FIG. 5). Iodoacetic acid eliminated growth at the 500 ppm and higher concentrations (FIG. 4), which was comparable to the Benalte control. In tetrazolium cell viability test, bromoacetamide and iodoacetamide (FIGS. 6 & 7) were comparable to a Benlate control (FIG. 10) with elimination of viable cells at the 100 ppm concentration. Iodoacetic and bromoacetic acids were effective at reducing cell viability to levels achieved with Benlate (100 ppm) at concentrations between 500 and 1000 ppm (FIGS. 8 & 9).

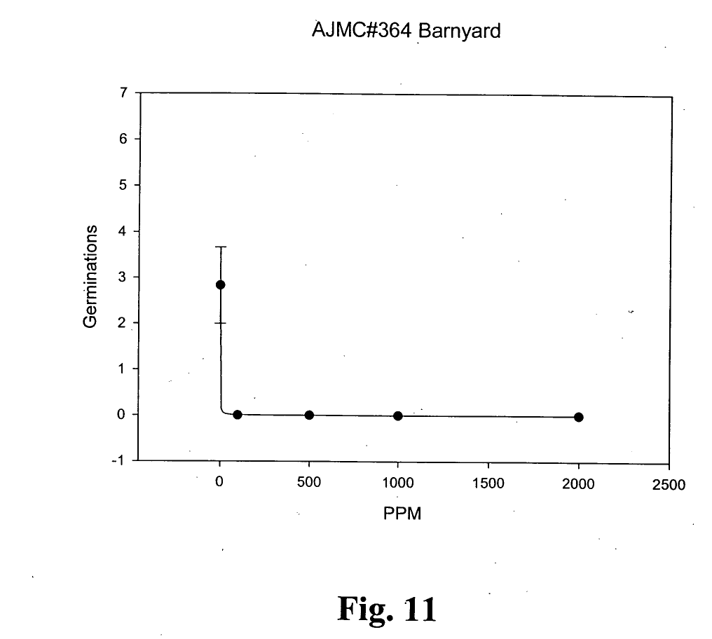

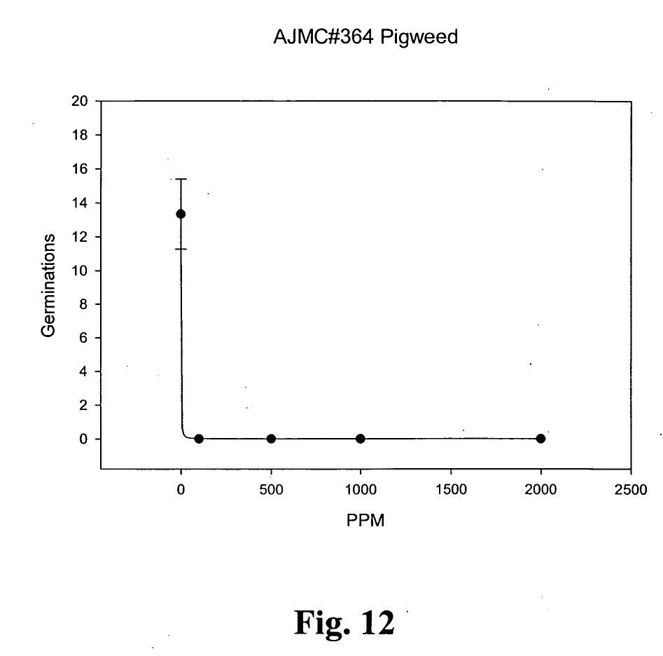

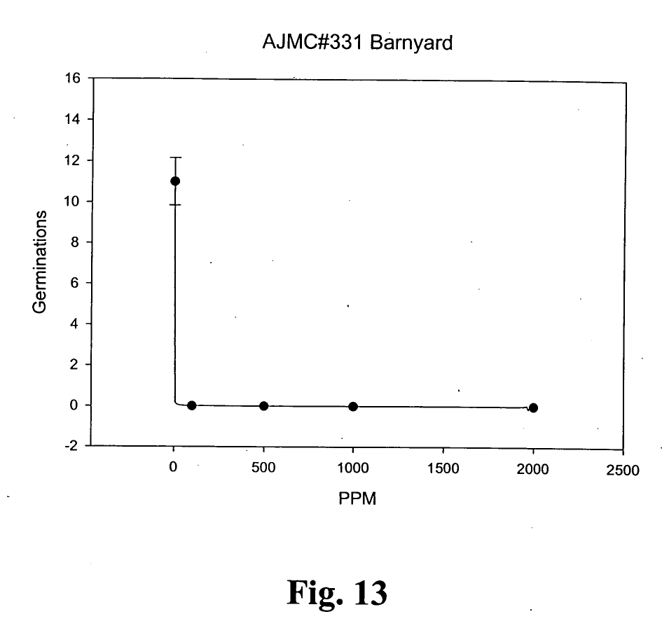

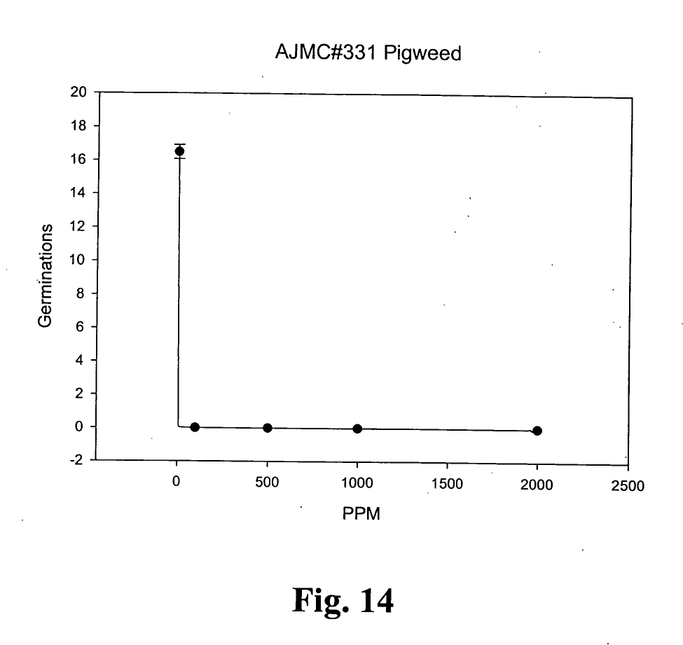

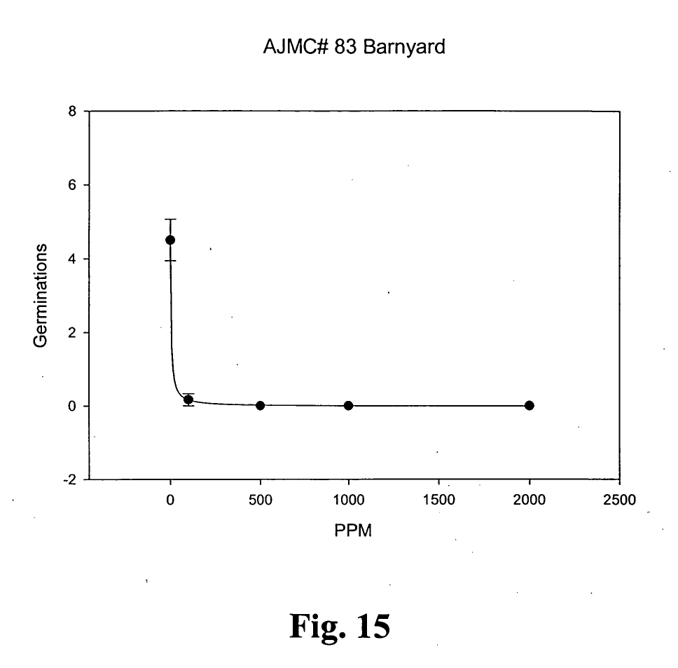

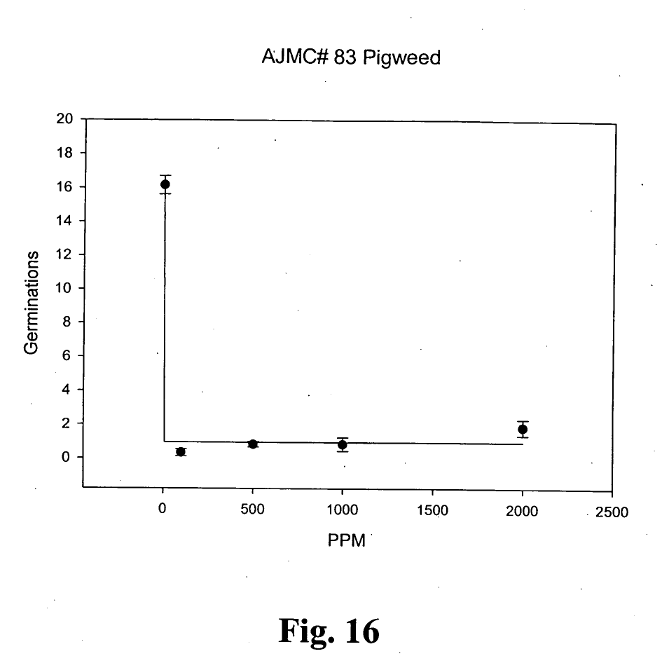

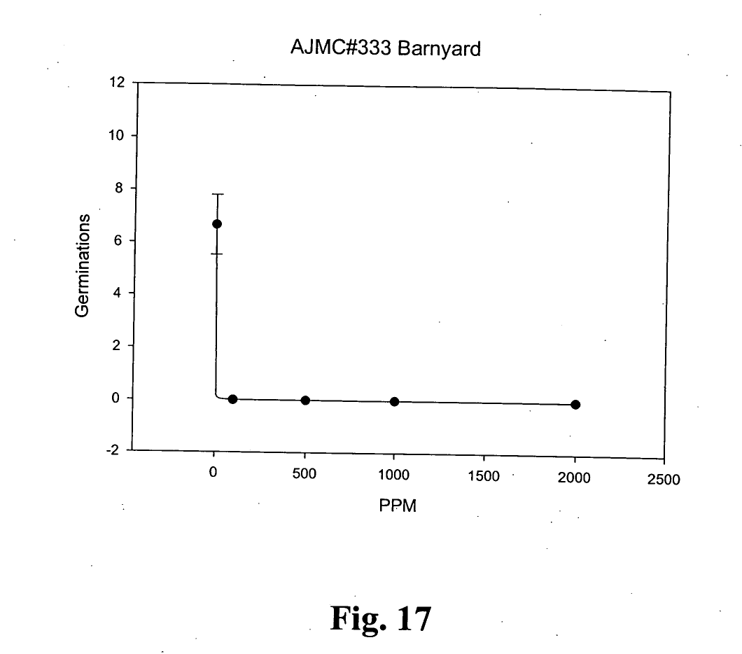

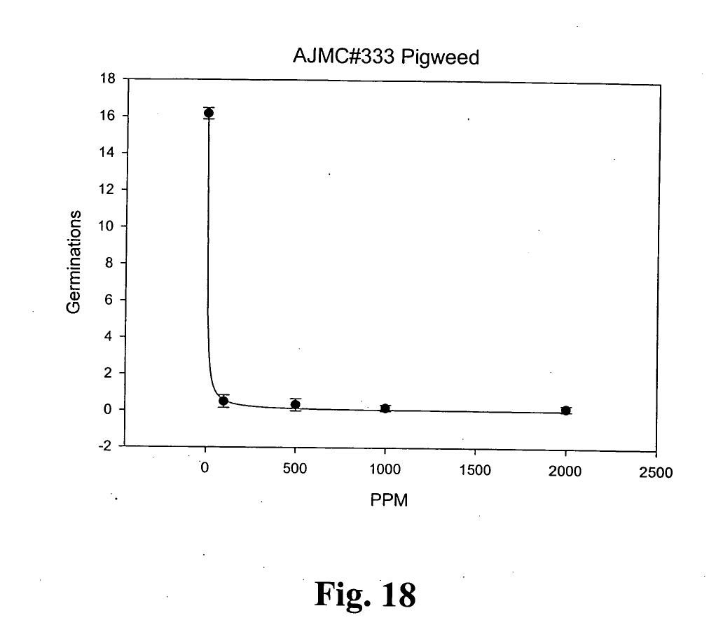

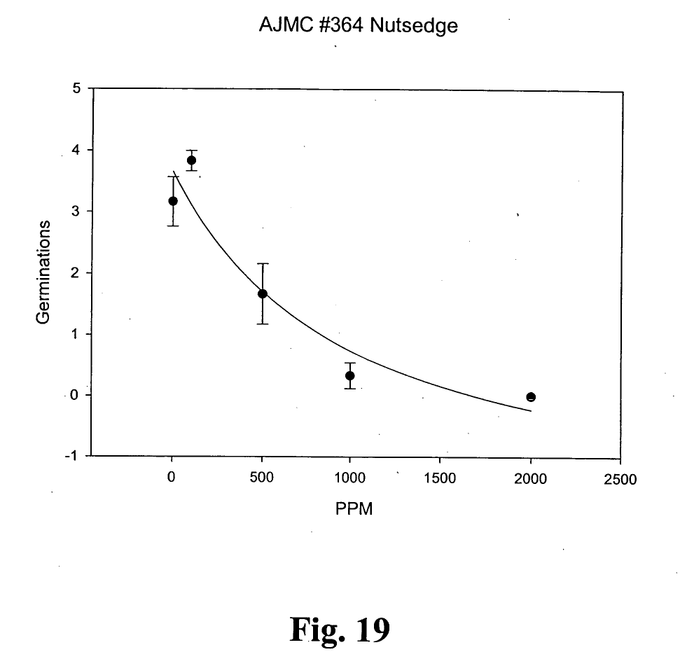

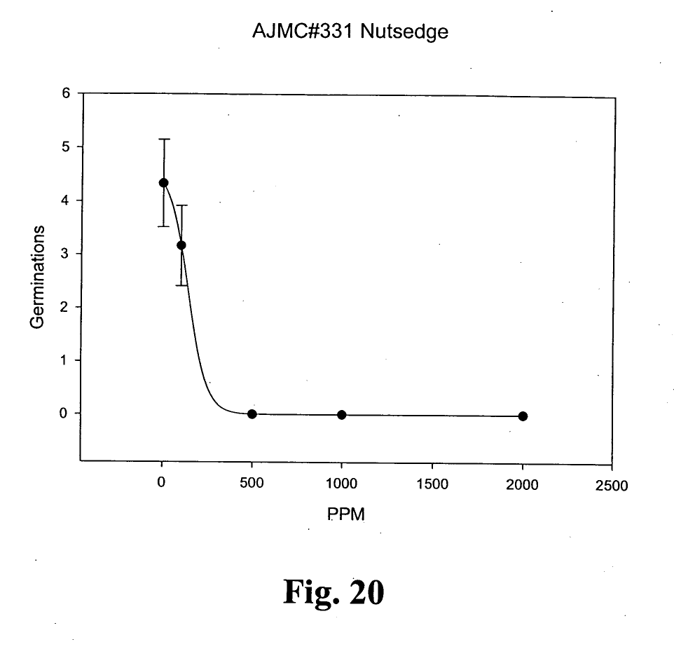

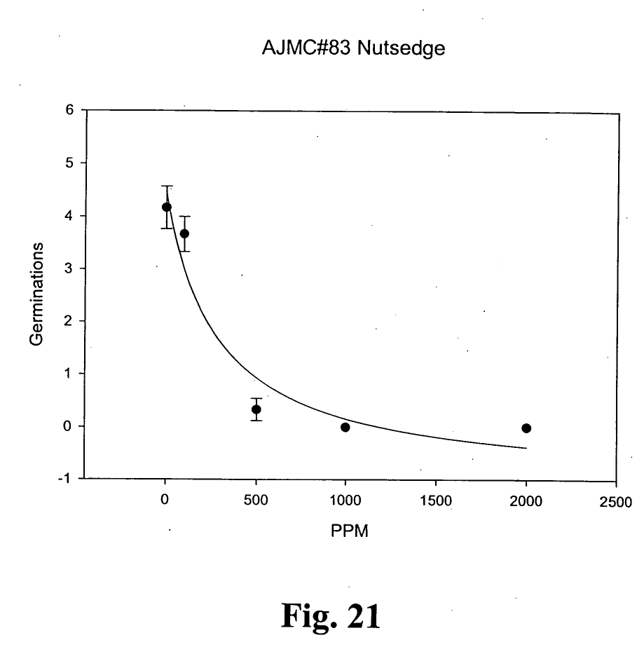

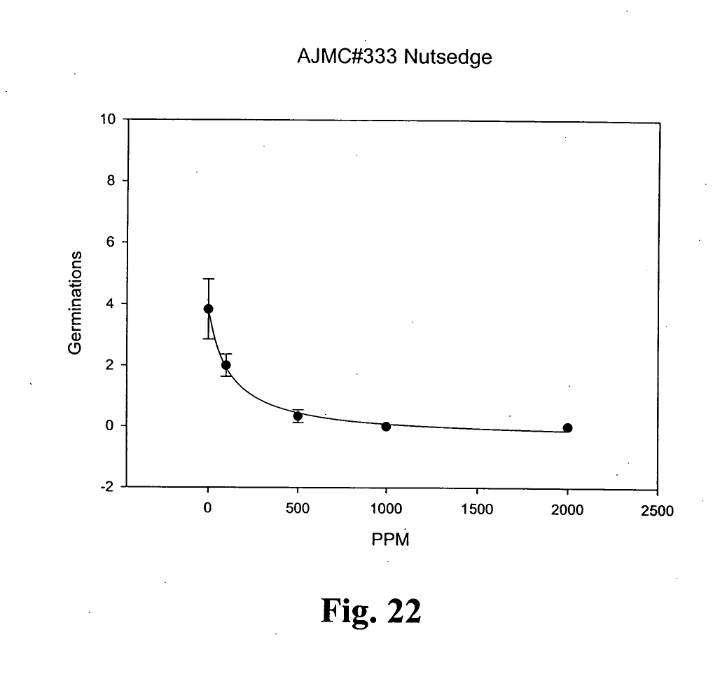

Herbicide Screen: Germination of barnyard grass and pigweed seeds was virtually eliminated at all ppm levels tested (FIGS. 11-18) of all compounds. Iodoacetamide, bromoacetic and iodoacetic acid were effective in eliminating the germination of nutsedge at the 500 ppm level and above (FIG. 20-22, 24 & 25). Bromoacetamide eliminated nutsedge germination at the 1000 ppm level and above (FIGS. 19 & 23).

Field Example: Field studies were conducted in Saint Lucie and Okeechobee Countyies, Florida from August through December 2003. Both sites were naturally infested with root knot nematode Meloidogyne sp. and nutsedge (Cyperus esculentus and C. rotundus). Both locations were planted with tomato cultivar Florida 47 after fumigation. Commercial cultural practices for the area were followed and University of Florida, Institue of Food and Agricultural Science fertilizer recommendations were used based on soil tests performed prior to fumigation. Water was maintained at both locations using seep irrigation. Pre-plant fumigation was performed three weeks prior to planting and raised beds were formed at the time of fumigation. The treatments were arranged in a randomized complete block design with four replications. Plots were one bed wide by 50 ft long at the Saint Lucie County site and one bed wide by 30 ft long at Okeechobee.

At both locations, methyl bromide : chloropicrin (98:2) was shank injected with two chisels into preformed beds that were immediately covered with white on black high-density polyethylene mulch. Injection rate of MB:CP was 400 lb per acre. Bromoacetic acid was applied to the pre-formed bed top using a back-pack sprayer at 600 and 800 lb per acre and beds were rototilled, reformed and covered with high-density polyethylene mulch.

Pest control assessments: Weeds were assessed by weighing the fresh biomass of the native weed population in three meter long sub-samples per plot. Weeds were uprooted and shaken to remove residual soil from the roots and then weighed to measure weed biomass. Weeds were then dried and reweighed. Weeds coming through the plastic and weeds coming up through the planting hole were assessed separately. Severity of root knot nematode infestations was assessed at harvest using a scale of 0-10 with 10 being a fully galled root. Plants were assessed for Fusarium wilt throughout the season.

Results and Discussion: Nutsedge pressure was high in both locations and weed control with bromoacetic acid at 800 lb per acre was as effective as methyl bromide for both fresh and dry weight of weeds emerging both through the plant hole and through the plastic (see Table 1). Nutsedge was the only weed emerging through the plastic. Weeds found in the planting hole were diverse. The 600 lb per acre rate was as effective as methyl bromide for controlling nutsedge emerging through the plastic, but not as effective against weeds in the plant hole. The 800 lb rate was as effective as methyl bromide in controlling nutsedge coming through the plastic and all weeds emerging in the plant hole. The nematode population was not evenly distributed at either test location and root galling at both locations was highly variable. Although some control from bromoacetic acid was apparent, it was not statistically significantly different from the untreated check. The number of Fusarium infested plants throughout the growing season was small in both locations and in all of the treatments, and the percentage of dead plants was not significantly different (P<0.05) among any treatments. The data regarding the Fusarium and nematode infested plants is considered insignificant due to the small populations of Fusarium and nematode infected plants in the locations treated. Bromoacetic acid was highly effective for weed control and shows promise for control of other pests in the absence of methyl bromide.

All of the references cited herein are incorporated by reference in their entirety. Also incorporated by reference in their entirety are U.S. Provisional Patent Application 60/395,230 filed on 11 Jul. 2002 and U.S. patent application Ser. No. 10/462,912 filed on 17 Jun. 2003.

Thus, in view of the above, the present invention concerns (in part) the following: A method for reducing pests in an object or area, comprising (or consisting essentially of or consisting of) applying to the object or area a pest reducing effective amount of a compound selected from iodoacetic acid, bromoacetic acid, 2-iodoacetamide, 2-bromoacetamide, or mixtures thereof (the compound may be used with an agronomically acceptable carrier(s) or carrier component(s)).

The above method, wherein the pests are fungi, insects, nematodes, bacteria, weeds, or mixtures thereof.

The above method, wherein the pests are fungi.

The above method, wherein the fungi are Fusarium spp.

The above method, wherein the pests are insects.

The above method, wherein the pests are nematodes.

The above method, wherein said nematodes are Meliodogyne spp.

The above method, wherein the pests are bacteria.

The above method, wherein the pests are weeds.

The above method, wherein the weeds are Amaranthus hybridus, Echinocloa crus-galli, Cyperus rotundus, or mixtures thereof.

The above method, wherein the object or area is soil, structures, agricultural commodities, plants, or mixtures thereof.

The above method, wherein the object or area is soil.

The above method, wherein the pest reducing effective amount is about 40 to about 1200 pounds/acre.

The above method, wherein the compound is iodoacetic acid.

The above method, wherein the compound is bromoacetic acid.

The above method, wherein the compound is 2-iodoacetamide.

The above method, wherein the compound is 2-bromoacetamide.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A method for reducing pests in an object or area, said method comprising applying to said object or area a pest reducing effective amount of a compound selected from the group consisting of iodoacetic acid, bromoacetic acid, 2-iodoacetamide, 2-bromoacetamide, and mixtures thereof.

2. The method according to claim 1, wherein said pests are selected from the group consisting of fungi, insects, nematodes, bacteria, weeds, and mixtures thereof.

3. The method according to claim 2, wherein said pests are fungi.

4. The method according to claim 3, wherein said fungi are Fusarium spp.

5. The method according to claim 2, wherein said pests are insects.

6. The method according to claim 2, wherein said pests are nematodes.

7. The method according to claim 6, wherein said nematodes are Meliodogyne spp.

8. The method according to claim 2, wherein said pests are bacteria.

9. The method according to claim 2, wherein said pests are weeds.

10. The method according to claim 9, wherein said weeds are selected from the group consisting of Amaranthus hybridus, Echinocloa crus-galli, Cyperus rotundus, and mixtures thereof.

11. The method according to claim 1, wherein said object or area is selected from the group consisting of soil, structures, agricultural commodities, plants, and mixtures thereof.

12. The method according to claim 11, wherein said object or area is soil.

13. The method according to claim 12, wherein said pest reducing effective amount is about 40 to about 1200 pounds/acre.

14. The method according to claim 1, wherein said compound is iodoacetic acid.

15. The method according to claim 1, wherein said compound is bromoacetic acid.

16. The method according to claim 1, wherein said compound is 2-iodoacetamide.

17. The method according to claim 1, wherein said compound is 2-bromoacetamide.
